(19) United States
(12) Patent Application Publication
(10) Pub. No.: US 2021/0027364 A1
(43) Pub. Date: Jan. 28, 2021

(54) METHOD AND SYSTEM FOR AN ELECTRONIC AUCTION

(71) Applicant: Epic Tech, LLC, Suwanee, GA (US)

(72) Inventors: Troy Jungmann, Leander, TX (US); Erik Nordin, Greenville, SC (US); Robert Weatherby, Flowery Branch, GA (US); Shay Randall, Edmond, OK (US); Timothy O. Caldwell, Piedmont, SC (US)

(73) Assignee: Epic Tech, LLC, Suwanee, GA (US)

(21) Appl. No.: 17/071,656

(22) Filed: Oct. 15, 2020

Related U.S. Application Data
(63) Continuation of application No. 15/431,354, filed on Feb. 13, 2017.
(60) Provisional application No. 62/293,933, filed on Feb. 11, 2016.

(51) Int. Cl. G06Q 30/08

(52) U.S. Cl. CPC G06Q 30/08

(57) ABSTRACT

An electronic auction method and system that determines a first number of bids that must be received, the receipt of which will end a reserve period of a first electronic auction and determines at least one additional number of bids that must be received, the receipt of which will end at least one additional electronic auction. A display simultaneously displays the first electronic auction and the at least one additional electronic auction, wherein the end point of the at least one additional electronic auction is displayed within the display of the first electronic auction. Each additional electronic auction ends upon receipt of the predetermined number of bids for that auction and ends the first electronic auction after all additional electronic auctions displayed within the first electronic auction have ended.

### CROSS-REFERENCE TO RELATED APPLICATIONS

The present application claims the benefit of U.S. provisional application Ser. No. 62/293,933, filed Feb. 11, 2016 entitled “METHOD AND SYSTEM FOR AN ELECTRONIC AUCTION.” The foregoing application is incorporated herein by reference as if set forth verbatim in its entirety and is relied upon for all purposes.

### BACKGROUND

Online auctions are a method of selling products to consumers. A consumer can typically purchase an item for a discount by participating in and winning the online electronic auction. The present system and methods are directed to electronic auctions.

### SUMMARY OF THE INVENTION

In an embodiment, the invention is directed to a computer-implemented method of providing an electronic auction.

### BRIEF DESCRIPTION OF THE DRAWINGS

A full and enabling disclosure of the present invention, including the best mode thereof directed to one of ordinary skill in the art, is set forth in the specification, which makes reference to the appended drawings, in which:

FIG. 1 shows a diagrammatic representation of an exemplary software system;

FIG. 2 shows an exemplary end user auction display; and

FIG. 3 shows a flow diagram depicting an embodiment of a method of the present invention.

### DESCRIPTION OF SOME EMBODIMENTS

Reference will now be made in detail to embodiments of the present systems and methods, one or more examples of which are illustrated in the accompanying drawings. Each example is provided by way of explanation, not limitation of the present system. In fact, it will be apparent to those skilled in the art that modifications and variations can be made to the present system and methods without departing from the scope or spirit thereof. For instance, features illustrated or described as part of one embodiment may be used in another embodiment to yield a still further embodiment. Thus, the present system and methods cover such modifications and variations as come within the scope of the appended claims and their equivalents.

The present systems and methods are directed generally to an electronic auction. In some embodiments, the auctions may be considered penny auctions or bidding fee auctions. In these embodiments, bids may be purchased for a fee and each bid placed in an auction may raise the final purchase price of the auction incrementally. Note that throughout this application, the electronic product used to participate in an auction is referred to as a “bid,” but, as used herein, this term includes any electronic product known in the art to be useful to designate participation in an electronic auction. Generally speaking, the software system provides a server-based and/or Internet-based auction.

In various embodiments, the system may be utilized in a brick and mortar store location. In a brick and mortar business, the inventive system may comprise software components for a management terminal, a cashier terminal (also called a point-of-sale or POS terminal herein), and/or an end user terminal. Any of the management terminal, cashier terminal, and/or end user terminal may be a kiosk, computer, or other terminal device. The management terminal software component may be used by a manager to run reports regarding cashier shifts, bids purchased, auctions won, products purchased, and the like, as well as manage the day-to-day business operations. In an embodiment, the cashier terminal aspect of the software may be utilized by a cashier to allow creation of an electronic auction account for each new user, account lookup for returning users, receipt of money from users, provision of free game pieces upon request pursuant to the alternative method of entry into the game promotion, and/or purchases of bids by end users. The cashier terminal software may include functionality to allow for printing of receipts for end users which summarizes their activities and/or provides them with a unique identification number. The end user terminal software component may be used by an end user to access the auction software within the brick and mortar facility, as will be more fully described herein. In an alternative embodiment, the customer may exit the brick and mortar location and access the electronic auction from any computer connected to the Internet.

In other brick and mortar establishment embodiments, the system comprises a purchase of bids by a customer directly through a user-operated terminal, such as a kiosk, computer, or other terminal (no human cashier necessary), which may be located in the brick and mortar location. In these embodiments, the software may still comprise software components for a management terminal, a cashier terminal, and/or an end user terminal, but the cashier terminal software may exist on the user-operated terminal. In fact, in any of these embodiments, software components for the management terminal, the cashier terminal, and/or the end user terminal may exist on separate terminals, may overlap on terminals, or may all exist on the same terminal. In the kiosk embodiments, a customer may approach the kiosk, computer, or terminal (hereinafter the “terminal”), input a method of payment, and purchase the desired number of bids. In various embodiments, the customer may then use the same terminal, a separate computer, or an end user terminal located in a brick and mortar location to access the electronic auction. In an alternative embodiment, the customer may exit the brick and mortar location and access the electronic auction from any computer connected to the Internet.

In alternate embodiments, access to the system, including purchase of bids, and use of the electronic auction can be implemented from any computer connected to the Internet and not related to a brick and mortar store. For example, the system could be accessed from a home computer, smart phone, or tablet. The system may be available over the Internet, or other Network, and all data may be stored on one or more physical servers and/or on a cloud server. The purchase of bids may be accomplished via credit card, debit card, PayPal® account, or similar service.

Regardless of how the customer accesses the system, the customer may be required to create an auction account prior to use of the system in an embodiment. If the user is a return user, he may need to use log-in credentials to access the system. Log-in credentials can comprise anything known in the art such as a username and password, a unique PIN, or the like. The user may be then prompted to view the auctions that are available and/or to purchase bids. Once bids have been purchased, the user may participate in one or more auctions.

In one embodiment, the customer purchases bids at an end user terminal, whether that is a home computer connected to the Internet, an end user terminal at a brick and mortar business location, or some other embodiment. In this embodiment, the purchased bids may be used for bidding on items for sale in the electronic auctions. The bids may be sold individually or in groups or packs. For example, bids may be sold in a pack of 100 bids. In some embodiments, bids may be sold in packages that have any known quantity of electronic bids. In other embodiments, the more bids the user purchases at a single time the lower the cost per bid. In various embodiments, bids purchased from the brick and mortar business, rather than from an Internet-based home computer, may be less expensive. For example, a bid pack purchased from the brick and mortar store may be $0.45 rather than $0.60 per bid. A bid purchase may be made by credit card, debit card, check or cash. In various embodiments, the purchase may be made by bank wire or any other suitable payment method.

In various embodiments, the electronic auction may be configured to receive and process bids from one or more users. In some embodiments, the auction is won by the person that places the highest bid or the last bid before the auction ends. In some embodiments, winning the auction entitles the winner to the auctioned product without further payment. In other embodiments, winning the auction requires payment of a cost associated with the auction win. In still other embodiments, all losing bidders may be able to purchase the auctioned item for a predetermined price. In some of these embodiments, the number of bids expended during the auction may be used to offset the final price that must be paid by the losing bidders or may be returned to the losing bidders.

As will be appreciated by one skilled in the relevant field, the present invention may be, for example, embodied as a computer system, a method, or a computer program product. Furthermore, particular embodiments may take the form of a computer program product stored on a computer-readable storage medium having computer-readable instructions (e.g., software) embodied in the storage medium. Various embodiments include web-implemented computer software. Examples of suitable computer-readable storage medium may include, for example, hard disks, compact disks, DVDs, optical storage devices, and/or magnetic storage devices.

Various embodiments are described below. It should be understood that, in some embodiments, each element of the invention can be implemented by a computer executing computer program instructions. These computer program instructions may be loaded onto a general purpose computer, a special purpose computer, smart mobile device, a gaming server, a gaming machine, or other programmable data processing apparatus to produce a machine. As such, the instructions may execute on any computer, which as used herein may include any general purpose computer, special purpose computer, smart mobile device, or other programmable data processing apparatus create means for implementing the functions described herein. The computer program instructions may execute entirely on the user's computer, partly on the user's computer, as a stand-alone software package, partly on the user's computer and partly on a remote computer, or entirely on the remote computer or server. In embodiments utilizing a remote computer, the remote computer may be connected to the user's computer through any type of network, including a local area network (LAN) or a wide area network (WAN), or the connection may be made to an external computer (for example, through the Internet using an Internet Service Provider).

These computer program instructions may also be stored in a computer-readable memory that can direct a computer or other programmable data processing apparatus to function in a particular manner such that the instructions stored in the computer-readable memory produce an article of manufacture that is configured for implementing the functions described herein. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified herein.

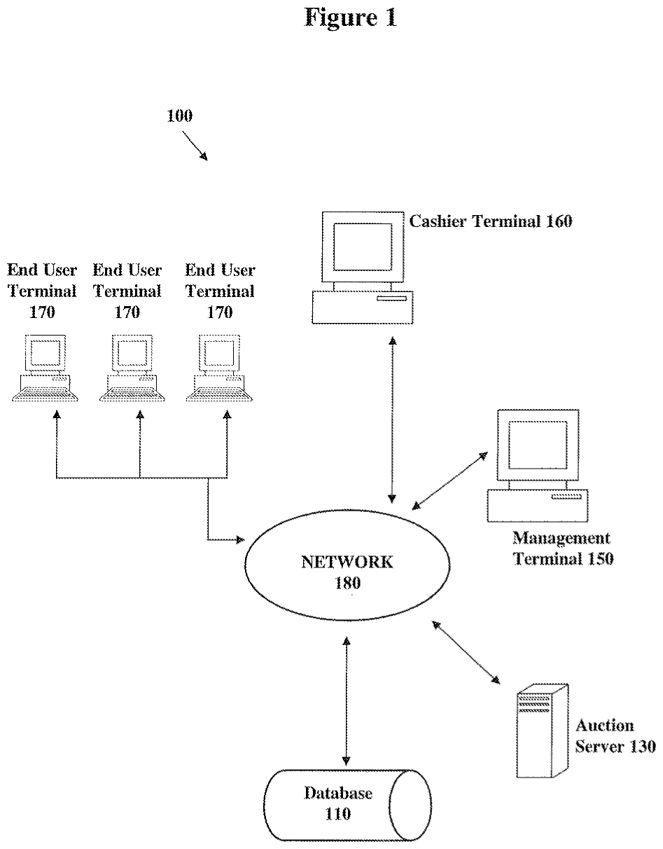

By way of example, and with reference to FIG. 1, the inventive system 100 may comprise a database 110, at least one auction server 130, at least one management terminal 150, at least one cashier terminal (also known as a point-of-sale terminal or POS terminal) 160, one or more end user terminals 170, or any combination thereof. Those skilled in the art with reference to this disclosure should appreciate that other configurations may be used to accomplish the methods described herein without departing from the scope of the present invention. For example, in various embodiments, the cashier terminal 160 and the end user terminals 170 may comprise the same device.

It should be understood that each of the computing devices, including the auction server 130, the management terminal 150, the POS terminal 160, and the one or more end user terminals 170 may each have a computer hardware processor, input and output devices (for example, a computer monitor, a keyboard, selection buttons, and/or mouse) and at least one storage device (for example, memory, hard drives, etc.). These devices may also have network connection cards to connect to the network. At least some of these devices may also include a computer readable medium, which is further described herein.

The auction server 130 may be configured to communicate data to and from various devices in the system and to perform one or more method steps, as detailed below. The database 110 may contain various types of data and computer instructions for performing at least some of the steps presented herein. It should be understood that the network 180 may be comprised of multiple auction servers 130 and multiple databases 110, whether located locally and networked through a LAN or remotely through a WAN or an Intranet connection. The end user terminals 170 may be linked together via a network. Each end user terminal 170 may be a standard standalone end user terminal, a kiosk, a personal computer (PC), a smart phone, a tablet, or other computing device.

The POS terminal 160 and/or the end user terminals 170 may allow a user to buy bids, buy products won in an auction, buy products not won in an auction, and/or manage user accounts. In various embodiments, the customer may use the POS terminal 160 to directly purchase bids to use in an online auction on the end user terminals. In some embodiments, a user account card may be issued by the POS terminal 160, which contains an electronic account detailing purchased bids and user account information. The user account card may be used to participate in electronic auctions and/or to place bids on items that the customer wishes to purchase.

If a user enters a brick and mortar location, a POS terminal 160 (through a cashier or directly) may provide the user with a receipt containing a code (such as a 16-digit hexadecimal code), a PIN, or a username/password that the user may then use for accessing the system or to access his/her account on an end user terminal 170. In an online embodiment, the user may access the inventive system through a browser interface that may provide a similar code to the user after account creation. This code may provide access to the auction software/website and/or specifically to the customer's account on the software/website. In various embodiments, the user may be required to input certain biographical information, such as name, phone number, username, password, date of birth, and/or email address when creating an account using any of the methods described herein. Such information may be stored in the database 110.

In various embodiments, the system may allow a user to deposit currency into an electronic wallet and then purchase bids on an as-needed basis. For example, in a brick and mortar business, the user may deposit money onto an electronic account at the cashier terminal 160, but has not yet purchased any bids until the user accesses the software at the end user terminal 170. In yet other embodiments, the system allows a customer to purchase electronic currency and later use that electronic currency to purchase bids. In still other embodiments, no electronic wallet is needed and the user may directly purchase bids (or other products) using a credit or debit card (or other payment method) directly, without inputting funds into an electronic wallet. In still other embodiments, a bid is purchased and used at the same time (i.e. bids are not purchased in advance and then used later, instead both purchase and use of a bid occur simultaneously).

The management terminal 150 may be a device that is operatively connected with the POS terminal 160, end user terminals 170, and/or auction server 130 to run cashier reports, calculate revenues and costs, track purchases of bids and products, and/or review auction and/or game promotion data. Other managerial or supervisory operations may also be performed using the management terminal 150.

The auction server 130 may control one or more operations of the online auction of items, such as creating online auctions, calculating reserve prices of online auctions, displaying the item(s) being auctioned, allowing purchase of bids, receiving bids, tracking purchased/used bids, tracking auction progress, initiating the start and end of an auction, tracking the winner of the auction, permitting purchase of a product won in an auction or otherwise, and/or any other operations as discussed herein.

One or more of the devices illustrated in FIG. 1 may be connected to network 180 as previously mentioned. In one embodiment, all devices in FIG. 1 are connected to the network 180 and communicate with each other over the network 180. It should be noted that the network 180 in FIG. 1 need not be a single network (such as only the internet) and may be multiple networks (whether connected to each other or not). In another embodiment, the network may be a LAN and a WAN (e.g., the Internet) such that one or more devices (for example, auction server 130, management terminal 150 and database 110) are connected together via the LAN, and the LAN is connected to the WAN which in turn is connected to other devices (for example, end user terminals 170). The terms “linked together” or “connected together” refers to devices having a common network connection via a network (either directly on a network or indirectly through multiple networks), such as one or more devices on the same LAN, WAN or some network combination thereof.

It should be understood that FIG. 1 is an exemplary embodiment of the present system and various other configurations are within the scope of the present system. For example, each end user terminal 170 may be located in a user's home. As another example, management terminal 150, point of sale terminal 160, and end user terminals 170 may all be located in a brick and mortar business location and auction terminal 130 may be located in still another location, where all of these system components are operatively coupled by a network such as the Internet. Additionally, it should be understood that additional devices may be included in the system shown in FIG. 1 and some devices shown in FIG. 1 may be omitted from a particular inventive system, such as, by way of example, the point of sale terminal. In other embodiments, certain devices may perform the operation of other devices shown in the figure.

For purposes of this disclosure, reference to a server or processor, shall be interpreted to include: a single server, a single processor; multiple servers; multiple processors; or any combination of servers and processors. In particular embodiments of the invention, any of the end user terminal 170, the cashier terminal 160, the management terminal 150, and the auction server 130 may be a computer. The computer may be connected (e.g., networked) to other computers by a LAN, an intranet, an extranet, and/or the Internet. The computer may operate in the capacity of a server or a client computer in a client-server network environment, or as a peer computer in a peer-to-peer (or distributed) network environment. The computer may be a PC, a tablet, a handheld device, a set-top box (STB), a Personal Digital Assistant (PDA), a web appliance, a server 120, 130, or any computer capable of executing a set of instructions (sequential or otherwise) that specify actions to be taken by that computer. Further, the term “computer” may also include any collection of computers that individually or jointly execute a set (or multiple sets) of instructions to perform any one or more of the methodologies discussed herein.

In some embodiments, the computer architecture may include a processor, a main memory (e.g., read-only memory (ROM), flash memory, dynamic random access memory (DRAM) such as synchronous DRAM (SDRAM) or Rambus DRAM (RDRAM), etc.), a static memory (e.g., flash memory, static random access memory (SRAM), etc.), and a data storage device, which communicate with each other via a bus.

The processor may be one or more general-purpose processing devices such as a microprocessor, a central processing unit, or the like. More particularly, the processing device may be a complex instruction set computing (CISC) microprocessor, reduced instruction set computing (RISC) microprocessor, very long instruction word (VLIW) microprocessor, a processor implementing other instruction sets, or processors implementing a combination of instruction sets. The processor may also be one or more special-purpose processing devices such as an application specific integrated circuit (ASIC), a field programmable gate array (FPGA), a digital signal processor (DSP), a network processor, or the like. The processor may be configured to execute processing logic for performing various operations and steps discussed herein.

The computer architecture may further include a network interface device. The computer architecture also may include a video display (e.g., a liquid crystal display (LCD) or a cathode ray tube (CRT)), an alphanumeric input device (e.g., a keyboard), a cursor control device (e.g., a mouse), and a signal generation device (e.g., a speaker).

The data storage device may include a machine accessible storage medium (also known as a non-transitory computer-accessible storage medium, a non-transitory computer-readable storage medium, or a non-transitory computer-readable medium) on which is stored one or more sets of instructions embodying any one or more of the methodologies or functions described herein. The online auction system may also reside, completely or at least partially, within the main memory and/or within processing device during execution thereof by a computer. The main memory and processing device also constitute computer-accessible storage media. Instructions may further be transmitted or received over a network via a network interface device.

While the machine-accessible storage medium may be a single medium, the term “machine-accessible storage medium” should be understood to include a single medium or multiple media (e.g., a centralized or distributed database, and/or associated caches and servers) that store the one or more sets of instructions. The term “machine-accessible storage medium” shall also be understood to include any medium that is capable of storing, encoding, or carrying a set of instructions for execution by the computer and that cause the computer to perform any one or more of the methodologies of the present invention. The term “computer-accessible storage medium” shall accordingly be understood to include, but not be limited to, solid-state memories, optical, and magnetic media.

The auction system that resides on auction server 130 may provide various auction functionalities as discussed herein. In various embodiments, the user may access the online auction site through end user terminal 170. In accessing the online auction site, the user may be presented with a welcome screen and asked to enter a code, username and password, or other identifying data. Once entered and confirmed, the system may permit the user to create or view his auction account. The user's auction account may contain information about the user, including, but not limited to, the user's preferences for information format, the user's biographical data, payment data, historical data, and/or number of bids available for use. The system may display an option for the user to view auctions in progress. If the user elects to view the auctions in progress, the user may view the products that are currently being auctioned, products that will be auctioned in the near future, and/or products available for outright purchase at their retail price. There may be one product available for auction or there may be multiple products available for auction. The products may be various consumer goods, such as cameras, phones, laptops, sports equipment, etc. In various embodiments, the products may be sporting event tickets, vacation packages, gift cards, bid packs, or any other product that may be sold through an online auction. Each auction may include photographs, product descriptions, product images, retail value, purchase price, or any other relevant information that may be displayed to the user to identify the product being auctioned.

In some embodiments, the auctions may each have varied ending points (i.e. number of bids received before the auction ends). In another embodiment, the auctions will each have varied reserve periods (i.e. number of bids received before the reserve period ends). For example, a KitchenAid® mixer may be auctioned off on January 3 and the number of bids required to end the reserve period or the auction itself may be 560. On January 5 (or even on January 3, the same day), an identical KitchenAid® mixer may be auctioned off and the number of bids required to end the reserve period or the auction itself may be 950. Similarly, an identical KitchenAid® mixer may be auctioned on January 17 (or any other day) and the number of bids required to end the reserve period or the auction itself may be 105 (or any other number). As such, the user cannot be certain of how many bids are required to end the auction and/or reserve period. Similarly described, the user cannot be certain of what final auction price will trigger the end of the auction and/or reserve period. This unpredictability creates an incentive for bidders to participate at early stages of the bidding, in the hope that the auction will end early and they will win the auction at a very low final auction price. It also creates an excitement to participating in the system.

Similarly, a KitchenAid® mixer may have a retail value of $299.00 and on January 3 the number of bids required to end the reserve period or the auction itself may be 560. On the same day, January 3, a Dyson® vacuum may have a retail value of $299.00 and the number of bids required to end the reserve period or the auction itself may be 560, 150, 1000, or any other number. Thus, the customer cannot assume that merely because two products have the same retail value, the auctions will end at the same point. In some situations, they may end at the same point, but in other situations, the ending points may vary.

In any of these embodiments, a goal may be to avoid predictability in the ending point of an auction, but also to have an average profit margin that ensures profitability. In an embodiment, the system accomplishes this through an inventive batching system. The inventors have developed a batching system in which the following steps can be accomplished manually, automatically, or any combination thereof.

In a first step, the batch is created. Products may be selected for a particular batch randomly, based upon the category of product (i.e. electronics or jewelry), based upon the value of the product, based upon the type of the product (gift card or electronics), or using any other method known. The batch may contain as few or as many products as is feasible. In some embodiments, it is preferable to create many small batches and in other embodiments, it is preferable to create one large batch, less frequently. In an embodiment, a batch could comprise only one product.

In a second step, a profit margin may be selected for each product individually. For example, the KitchenAid® mixer may require a profit margin of 15% while the Dyson® vacuum may require a profit margin of 12%. Again, this step may be conducted manually or automatically, based upon previously input information. In some embodiments, the profit margin selected in step two is a baseline and may be adjusted in later steps.

In an optional third step, other features may be selected, such as, for example, the number of available items for the buy-it-now feature or for outright purchase, the number of free bids to be awarded, and/or the number of prizes to be awarded within each auction.

In a fourth step, once the entire batch has been created, profit margins have been applied to individual items, and everything is finalized, a minimum profit margin, a maximum profit margin, and an average profit margin may be selected or applied across the entire batch. For example, although the KitchenAid® mixer started out with a profit margin of 15% and the Dyson® vacuum started out with a profit margin of 12%, those margins may be adjusted in this step. If the minimum profit margin selected is −100%, the average profit margin selected is 15%, and the maximum profit margin selected is 200%, the system will randomize the profit margin (and, in turn, the number of required bids and final auction price) for each individual item such that the average profit margin for all products in the batch is 15%, but some may have a profit margin of −100%, some may have a profit margin of 200%, and many will have profit margins between −100% and 200%. Thus, it is these steps that determine the final auction price and number of required bids for each auction item. This batching process ensures profitability for the company's standpoint and unpredictability and interest from the consumer's standpoint.

In a fifth step, once the batch is created, the batch is loaded into one or more queues. Again, this step may be performed manually or automatically. In an embodiment, a queue organizes the order in which the products will be offered for auction. In an embodiment, multiple queues are available at any given time. In an embodiment, the number of queues corresponds to the number of live auctions available. The queues may or may not have any relationship to the batches. The queues may be loaded from one batch or may be loaded from multiple batches. In an embodiment, a second item cannot be auctioned off unless and until the first item in the queue has been auctioned off. Once the first item's auction closes, the second item in the queue becomes available for auction. Queues may be loaded based upon the cost of the items, the popularity of the items, the category or type of the items, or any other rational known in the art.

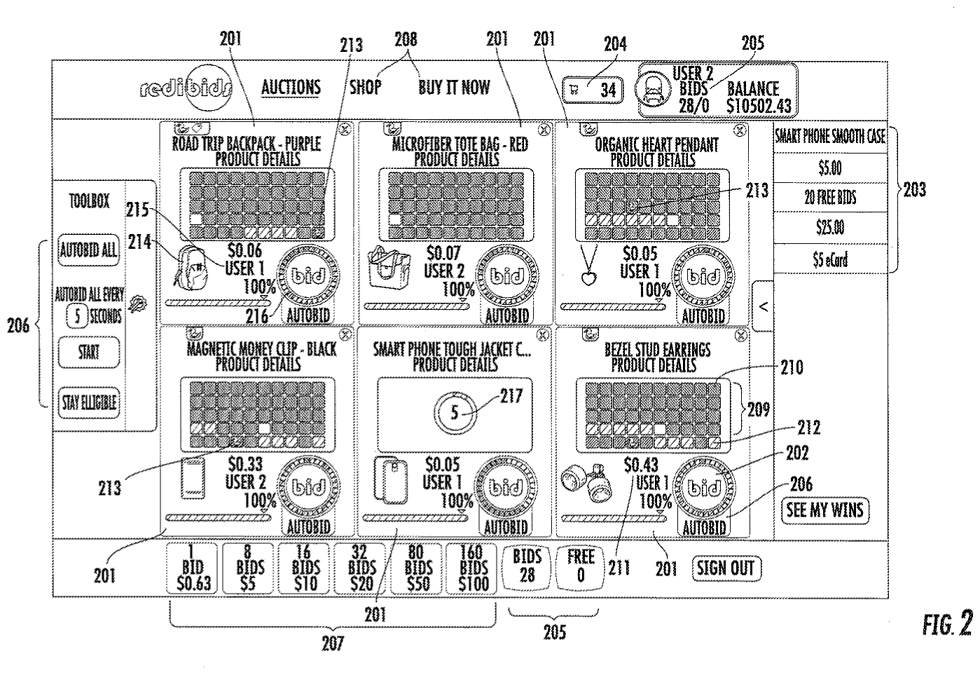

In an embodiment, illustrated in FIG. 2, one or more auctions 201 may be displayed onscreen. In an embodiment, the auctions 201 are automatically preselected by the system and displayed onscreen to the end user. In another embodiment, the user selects the auctions 201 individually, from various categories, or using any other mechanism known. In the embodiment shown in FIG. 2, up to six auctions 201 can be selected, but it should be appreciated that any number of auctions may be selected in various embodiments. There may be alternative embodiments that display eight (8) onscreen auctions 201 or twenty (20) onscreen auctions 201 or one hundred (100) onscreen auctions 201.

In an embodiment, the auctions 201 may have a similar feature, such as being related in theme (sports-related or electronics-related). Alternatively, the auctions 201 may be similar in retail value or may have some other similarity. The auctions 201 may be displayed in a tile or grid format, a circular format, a square format, a diagonal format, or in any format known in the art. The auctions 201 need not have a symmetrical appearance or any particular format. One or more of the auctions 201 may be displayed larger than the other auctions.

A bidder may be able to individually place bids on each auction 201 that is displayed. The bidder may place bids using a “bid” button 202, or a comparable onscreen button. In an embodiment, each time the “bid” button 202 is pressed, one bid is placed in that particular auction 201. Placing a bid in an auction 201 may incrementally increase the auction price. In some embodiments, the auction price will increment by one penny (one cent) each time a bid is placed by any user. In other embodiments, an auction price may increase by a fraction of a penny for each bid that is placed ( 1/10 of a penny, for example). In still other embodiments, the auction price may increase by five (5) cents, or any other amount, each time a bid is placed. As used herein, “auction price” means the price that the winner of the auction will have to pay in order to purchase the product. The auction price may be lower, and in some cases dramatically lower, than the retail price of the product.

The auction display may include features such as a graphical or written listing of previous auction products that the user has won 203, historical data for similar auctions, a link to the user's shopping cart 204, a link to rules and/or terms and conditions, links for various features, links for user account information, a listing of the number of bids available or remaining in the user's account 205, a button used to bid on auctions 202, “autobid” buttons 206, buttons, links, lists, or graphics that allow the user the view other auctions, buttons or links used to purchase more bids 207, and/or buttons or links that allow the user to purchase the product at its retail price or a discounted retail price 208. Any graphical depiction of buttons or links may be utilized. The auction display may, in an embodiment, also include a photograph or graphical representation of the product 214 being auctioned. The auction display may display the username 215 of the highest or last bidder.

In a particular embodiment, shown in FIG. 2, each individual auction will display a grid 209 for one or more auctions. The grid 209 may contain a number of bid spaces 210 (boxes, circles, or any other configuration) that indicate when a bid has been placed. The bid spaces 210 within the grid 209 may be symmetrically displayed in lines, may be asymmetrical in nature, or may be any configuration known. In an embodiment shown in FIG. 2, the grid 209 is shown as five (5) lines, each containing ten (10) boxes, for a total of fifty (50) bid spaces 210 viewable at any given time. This configuration, however, is just an example and should not be limiting. The grid may comprise any number of bid spaces 210 displayed in any configuration. In an embodiment, the grid display 209 advances as bids are placed. For example, each time ten (10) total bids are placed in the grid 209 shown in FIG. 2, the grid advances such that a new line of ten (10) bid spaces are shown at the top of the grid and the bid spaces at the bottom of the grid, which already have bids placed in them, disappear from view. Similarly, in the embodiment shown in FIG. 2, each time ten (10) bids are placed, the final auction price 211 increases by one penny.

In an embodiment, the visual display allows each end user to see his or her placed bids 212 displayed in one color (red, for example) and bids placed by other users displayed in a different color (blue, for example). In an embodiment, the grid spaces 210 are yet a different color (black or gray, for example) until a bid has been placed and, as the bids are placed, the grid space changes color (from black or gray to blue or red, for example). In an embodiment, the grid spaces 210 continue to repopulate until the auction ends. In other embodiments, other designations may be used to display the status of such grid spaces 210, such as symbols.

In an embodiment, mini-auctions 213 are provided within the auction grid 209. The term “mini-auction” 213 (also referred to as “additional auction”) as used herein, means an auction presented within the larger auction grid. The mini-auctions 213 may be displayed using a symbol or any suitable designation. In FIG. 2, those symbols are shown as ducks, but any symbol known in the art can be used. Different symbols may be used for different types of prizes. For example, a duck symbol could be used to designate a product mini-auction, a gift box symbol could be used to indicate a free bid mini-auction, and/or a gift card symbol could be used to designate a gift card mini-auction.

In order to win a mini-auction 213, in an embodiment, the bidder must simply place the bid that corresponds to that symbol. Said another way, the bidder must time his or her bid such that it lands on the grid space 210 that contains a mini-auction symbol 213. In an embodiment, the mini-auctions 213 and the main auction 201 may be operatively linked. As used herein, operatively linked means that operation of the mini-auction 213 and the main auction 201 proceed simultaneously, with each mini-auction operating in conjunction with a main auction 201. In an embodiment, described more fully herein, this comprises a main auction 201 which has a grid 209 and within the grid 209 there are multiple mini-auctions, wherein the end point of each mini-auction is designated with a symbol 213. In this respect, the mini-auction 213 and the main auction 201 operate together, in a linked manner. To an outside observer, the system may even appear as one singular auction with many prizes available within that auction. As one bid is placed in the mini-auction, that same bid is also, simultaneously, placed in the main auction and progresses the main auction. Said another way, as one bid is placed in the main auction, the same bid is also, simultaneously, placed within at least one mini-auction. The mini-auctions may be displayed in any manner which introduces excitement into the main auction.

In an embodiment, only qualified users may visibly see the mini-auction symbols 213. For example, if a bidder places a bid, he may be qualified for a certain period of time, 30 seconds, for example, within which he can visibly see the mini-auction symbols 213. Each time a bidder places a bid, he may get an additional 30 seconds of visibility for the mini-auction symbols 213. In an embodiment, a bidder may win a mini-auction 213 regardless of whether or not he can visibly see the mini-auction symbols 213. The qualification aspect of seeing the symbols may be based upon any qualification requirements known in the art. For example, the ability to see the symbols may be based upon how many bids a bidder has placed in the auction thus far, how many bids a bidder has placed in all auctions that day, whether the bidder has bid within a previous set timeframe, or whether the bidder was one of a certain number of previous bidders. The qualification aspect of the system may be graphically displayed to the bidder. In the embodiment shown in FIG. 2, the bidder's eligibility is displayed visually as a circular timer 216 that ticks down and changes color as the bidder nears the end of his eligibility period.

In a particular embodiment, each time the bidder places a bid, he becomes qualified or eligible to see the mini-auction symbols for a set period of time. The period of time may be 15 seconds, 30 seconds, or any set time period. The time period may accumulate with each bid placed or it may be limited to a maximum amount of time, 30 seconds for example. In an embodiment, the qualification/eligibility of the bidder may be indicated by a circular timer that counts down, a color change (for example, green to yellow to red), a meter (for example, a circular meter that visually indicates how much time remains), or any other indicator.

In an embodiment, a bidder must be eligible not only to see the symbols 213 in the mini-auctions, but also to win an auction 201. Alternatively, qualification/eligibility may be required for the auction 201, but not the mini-auctions 213. In these embodiments, only an eligible bidder can win the auction 201. In a particular embodiment, once the set number of bids has been placed, the eligibility aspect of the auction begins. Said another way, once the set number of bids has been placed, the reserve period ends. In order to move beyond the reserve period and win the auction, the bidder must be eligible. In an embodiment, once the reserve period ends, a countdown timer 217 begins (shown in an embodiment in FIG. 2) and the last bid placed prior to the end of the timer 217 is the winner. The timer may or may not reset with each successive bid placed. As used herein, the term “reserve period” will refer to the portion of the auction prior to the receipt of the set number of bids; the term “countdown period” will refer to the portion of the auction after receipt of the set number of bids.

Eligibility for the countdown period may be based upon a variety of factors. For example, the eligibility requirement for the countdown period of the auction may be that the user has placed a bid within a set time frame. This timeframe could be within 30 seconds, 60 seconds or any number of seconds prior to the end of the reserve period. Likewise, the eligibility requirement could be that only the users that placed a minimum number of bids in the reserve period of the auction are eligible for the countdown period. In another embodiment, only a set number of the most recent bidders will be eligible for the countdown period. For example, the last 20 bidders before the reserve was met may be eligible for the countdown period.

In an embodiment, the auction has an eligibility indicator 216. In this embodiment, if the user bids within a certain timeframe, within 60 seconds for example, they maintain eligibility for the countdown period. There may be a visual display of the user's eligibility shown to each user. For example, an eligibility timer may be shown to the user, such that when the eligibility timer runs out, the user is aware that he is no longer eligible to participate in the countdown period. The user's eligibility may be indicated with symbols or colors. For example, the user's eligibility may be indicated as a color change from green (eligible), to yellow (close to ineligible), to red (ineligible). Any visual indicator that notifies the user of eligibility could be used in this embodiment.

In an embodiment, if a bidder is not eligible at the end of the reserve period, the auction will continue into the countdown period and the ineligible bidder will be prevented from participating. In an embodiment, the ineligible bidder cannot visually see the countdown period at all. In another embodiment, the ineligible bidder can watch the progress of the countdown period, but cannot participate in the countdown period. In an embodiment, an ineligible bidder cannot win the auction. In an embodiment, an ineligible bidder cannot create eligibility by bidding during the countdown period. However, as noted, other embodiments of the present invention may optionally not include a countdown period.

In an embodiment, the system may limit the number of individual bidders that may participate in any particular auction at a given point in time. For example, the maximum number of bidders in an auction may be 50 bidders, 100 bidders, or any number of bidders. The maximum number of bidders may be variable and/or may be calculated based upon how quickly auctions are ending. In an embodiment, the auctions will end quickly. The maximum number of bidders permitted in an auction may be limited so that each auction ends after approximately 15 seconds, 20 seconds, 25 seconds, 30 seconds, 35 seconds or any other time frame. In an embodiment, the number of bidders is limited such that each auctions ends in less than 5 minutes. In another embodiment, the number of bidders is limited such that each auctions ends in less than 1 minute. In an embodiment, the number of bidders is limited based on live or historical user bidding pace, such as, for example, using predictive analysis to calculate the approximate end time of a given auction based on a potential or actual number of bidders.

In an embodiment, the system may limit the entry of bidders into an auction based upon skill level or number of previous wins. In this embodiment, there may be, for example, beginner auctions and expert auctions.

When an auction ends, in an embodiment, the screen position for that auction may be repopulated with another similar item. For example, if a BestBuy® gift card auction ends after 53 bids, the position may be automatically refilled with a DVD player or a Wal-Mart® gift card of similar value.

In some embodiments, a bidder can only participate in one auction at any given time. In another embodiment, a bidder may be able to participate in multiple auctions simultaneously. In an embodiment, the system allows a bidder to simultaneously bid on each item in their selection by pressing only a single bid button.

In some embodiments, the system provides an automatic bidding feature that, if selected, automatically bids for the user using any number of methods. For example, the system may autobid every certain number of seconds, or it may autobid if another bidder outbids the bidder in the auction room. In some embodiments, a user may be able to customize the Autobid feature, specifying the time frame within which it will place bids or the bidder may be able to select from one or more default Autobid options.

With regard to the user interface, the system may provide a designated area in the user interface that displays the real-time status of the one or more auctions selected by the user. This may include a designation of the current number of bidders participating in the auction, the current auction price for the item, previous prices at which auctions for similar products have ended, an average price at which auctions for similar products have ended, and/or other relevant data. The auctions status may also be delayed and not necessarily shown in real-time depending on the embodiment of the system.

In various embodiments, the auction may be local and server-based. The products being bid upon may be accessed only by users in a particular brick and mortar location where the relevant auction server is located or, in another embodiment, in a particular city, county, or state where the relevant auction server is located. In another embodiment, however, the same auctions may be accessed by any customer across various states or nationwide. In this embodiment, the inventive system and data may be housed in a centralized server and/or cloud server.

In some embodiments, the bidding may be conducted via a reserve price auction or a minimum bid auction. In this type of auction, a reserve price may be hidden to bidders. In some embodiments, there may be no reserve price at which the auction ends, but a specified number of bids which determines the end of the auction. In this embodiment, the auction ends when the reserve price or number of bids is met. The last bidder to place a bid wins the auction.

In some embodiments, a countdown timer is used to indicate the auction end. In an embodiment, the countdown timer does not reset if a bidder bids within the countdown period. In other embodiments, if a bidder places a bid during the countdown period, the countdown timer may reset. In still another embodiment, the auction ends at a selected time, which may be hidden from the user, and the last bidder wins the auction. In a particular embodiment, there is a maximum number of bids that can be accepted before the auction ends. In still other embodiments, the reserve model is utilized, but when the reserve price or number of bids has been met, the auction enters a “countdown mode,” in which the last bidder to bid, amongst the eligible bidders, wins the auction.

In various embodiments, when the auction ends any bidder that did not win the auction may have the option to purchase the product he was bidding upon, or optionally, any product offered for auction or available on the system, at its listed retail price. In a particular embodiment, the bids that were used in bidding for the product may be converted to currency and be debited against the price of the retail product. For example, if each bid costs $0.10 and a user bids 10 times on a $5.00 gift card, but loses the auction, he may purchase the $5.00 gift card for $4.00 (retail value minus cost of bids used in unsuccessful auction). Thus, the monetary value of the bids is maintained. Other embodiments include the ability to debit a portion of the cost of bids used in unsuccessful auctions. In an embodiment, the losing bidder may purchase the item at retail cost and the bids used in that auction may be returned to the bidder. In an embodiment, only bids actually purchased can be redeemed in this manner. Any combination of these options may be utilized in the present invention. In various embodiments, the system may be configured to not allow the user to debit bids awarded free of charge against the retail cost of a product.

In an embodiment, if the user fails to use all of his bids during a particular session, those bids will be stored in his user account until he returns to the store/website. The user may utilize those bids at a later date.

With reference to the drawings, FIG. 2 illustrates an embodiment of the display on a screen of a user interface. Six (6) auctions are shown in a grid pattern in the center of the screen. At the bottom of the screen, a button display 207 allows the purchase of additional bids. The “See My Wins” panel, on the right side of the screen, identifies the auctions the user has already won and the final auction price of those auctions. “Bid” buttons 202 are shown near each individual auction and various autobid options are displayed within the Toolbox on the left of the screen. In the top right of the screen, the number of bids and balance remaining in the user account is shown. Additionally, links 208 are shown that take the user to the Auctions, Shop, and Buy It Now features. A shopping cart 204 on the top panel indicates the number of items queued for purchase and links the user to those items. The eligibility timer 216 is displayed as small rectangles that encircle the bid button of each auction. As the eligibility timer 216 changes color from green, to yellow, and to red, the bidder is warned that his eligibility is coming to an end. If the eligibility indicator is grey, the user is no longer eligible and cannot, in this example, visibly see the duck prizes that may exist within the grid. The example set forth in FIG. 2 additionally shows several mini-auctions 213, indicated by the duck symbols embedded within the grid. In this example, the user may hover over or click on a duck symbol and may view a description of what the mini-auction comprises. In another embodiment, the product made available in the mini-auction may be hidden from all bidders until the mini-auction ends. In some embodiments, a bidder must pay a flat fee (i.e. $1.00 for all mini-auctions) for the item won in a mini-auction. In other embodiments, the item is won outright through a mini-auction. In still another embodiment, the fee for the product won in a mini-auction is based upon how many bids were placed prior to the end of that mini-auction.

In various embodiments, other symbols may appear within the grid shown in FIG. 2. For example, additional symbols might be shown which would indicate free bid mini-auctions and/or gift card mini-auctions. In an embodiment, the mini-auctions are randomly placed within the grid. In another embodiment, the mini-auctions are placed so that at least one mini-auction is presented per set number of grid spaces. For example, the system may display 2 mini-auctions per every 50 grid spaces. Any number of mini-auctions may be displayed.

In an embodiment, the system is designed to assign the mini-auctions to various grid spaces randomly. In an embodiment, the system intentionally places the mini-auctions in certain portions of the grid. In an embodiment, the system randomly assigns the mini-auctions to various grid spaces, but then conducts a self-check to determine if the mini-auctions are well-distributed throughout the grid. If the mini-auctions are not well-distributed throughout the grid, the system redistributes the mini-auctions, either entirely or on an individual basis. For example, the system may conduct a check to determine if there is at least one (or two or three or any other number) mini-auction in each consecutive 50-space section of the grid and, if there is not, it may redistribute the mini-auctions or add additional mini-auctions.

This example includes a display for each auction indicating the username for the most recent bidder and a display of the current auction price. The example also includes a Buy It Now meter which indicates, by percentage, the number of bids the bidder has placed toward the retail value of the item. If the Buy It Now meter registers 100%, the bidder has used enough bids to equal the retail value of the item.

In addition, there may be a screen display that shows an individual's auction history, such as how many bids he or she used, how many auctions he or she won, and/or how many products he or she bought at the auction price.

It should be understood by reference to this disclosure that these methods describe exemplary embodiments of the method steps carried out by the present system, and that other exemplary embodiments may be created by adding other steps or by removing one or more of the methods steps described herein.

In various embodiments, the system may require a user to log in to his or herSte account, optionally from end user terminal 170, by providing credentials (e.g., a user name or account number and password or other identifying credentials). In some embodiments, the user may be asked to create an account. In still further embodiments, the system may allow a user to proceed with a one-time account or to log in as a “guest.”

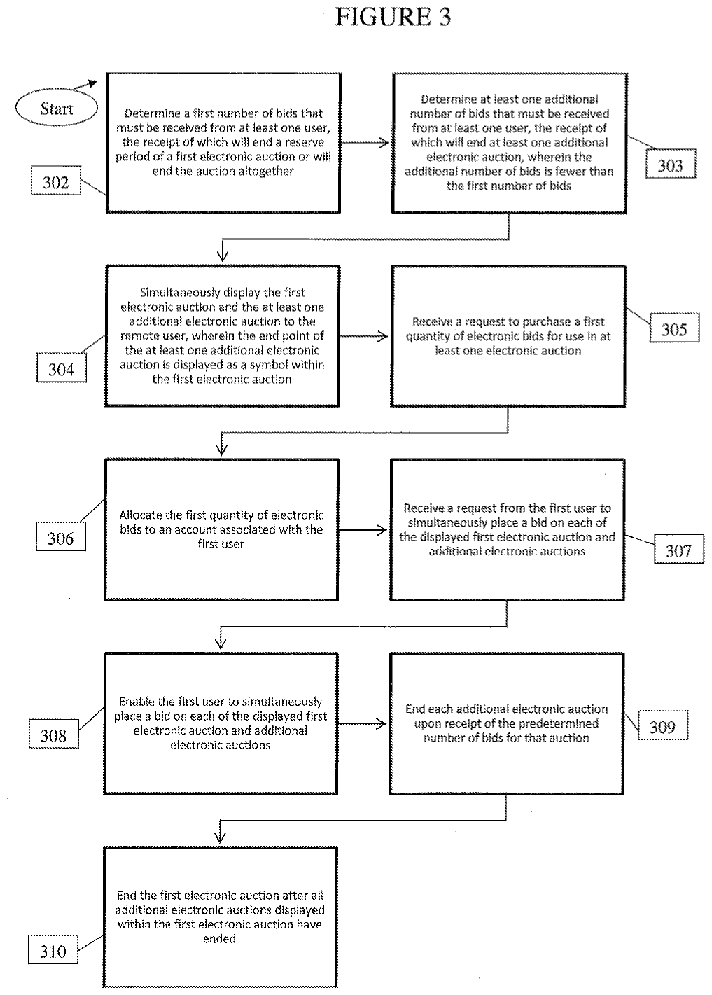

In an embodiment, shown in Step 302 of FIG. 3, the inventive system may first determine a first number of bids that must be received from at least one user, the receipt of which will end a reserve period of a first electronic auction. In an embodiment, the end of the reserve period of the first electronic auction is the end of that auction. In this embodiment, the number of bids that ends the reserve period of the auction is the same number of bids that ends the auction itself. In Step 303, the inventive system may determine at least one additional number of bids that must be received from at least one user, the receipt of which will end at least one additional electronic auction, wherein the additional number of bids is fewer than the first number of bids. Steps 302 and 203 may be conducted simultaneously or may be conducted one after the other, in any order. For example, in an embodiment, Step 303 may be conducted prior to Step 302. Step 303 could comprise just one additional auction, four additional auctions, fifteen additional auctions, eighty additional auctions, or any other number of additional auctions. The additional auctions may be referred to herein as “mini-auctions.”

The system may then simultaneously display the first electronic auction and the at least one additional electronic auction to the remote user, wherein the at least one additional electronic auction is displayed within the first electronic auction, as shown in Step 304. As used herein, the term “within the first electronic auction” means that the mini-auctions are displayed within, or inside the confines of, the first electronic auction. This may mean that the first electronic auction is displayed in a grid format (as shown in FIG. 2) and the end point of each of the additional auctions may, in an embodiment, be displayed within, or on, one grid space within the grid of the first electronic auction (also shown in FIG. 2). For example, the end point of each additional auction may be displayed as a symbol, such a stop sign, check mark, duck, devil, gift box, or gift tag. The end point of each additional auction may be displayed using a color change. For example, the space indicating the end of an additional auction may be blue and the rest of the spaces may be red. In an embodiment, symbols, colors or any other visual or audible indicator may indicate the beginning and/or end of any additional electronic auction.

The first auction may be displayed in any format known and should not be limited to a grid format or shape. In an embodiment, whatever the display format of the first auction, each additional auction (beginning, end, or the entirety thereof) is visually displayed and/or accessed within the visible confines of that first auction or is otherwise connected to the progress of the first auction. For example, in an alternative embodiment, a meter may show progress toward the additional auction as opposed to designating a grid space as shown in FIG. 2.

In Step 305, the system may receive a request to purchase a first quantity of electronic bids for use in at least one electronic auction. The system may receive the request from end user terminal 170. In some embodiments, the request may be for any quantity of electronic bids. In other embodiments, the system may place restrictions on the quantity of bids a user may purchase. For example, the system may require the purchase of a minimum quantity of electronic bids. Alternatively, the system may place an upper limit on the quantity of electronic bids a user may purchase. In some alternative embodiments, a user may have previously purchased bids and this step may be optional.

The system may then allocate a first quantity of electronic bids to an account associated with the first user, as shown in Step 306. As shown in Step 307, the system receives a request from the first user to simultaneously place a bid on each of the displayed first electronic auction and additional electronic auctions. In an embodiment, separate bids are not placed in the first auction and each additional auction. That is, each bid that is placed qualifies the user and/or makes him eligible to win each of the first and additional auctions. A single bid could be the final bid needed to win any of the additional auctions or the first auction. Said another way, a user could win any of the first auction or the additional auctions by placing a single bid. In an embodiment, each bid that is placed may simultaneously advance or increment the progress of the first electronic auction and each additional electronic auction. In an embodiment, each of the additional auctions that are displayed within the first auction end prior to the end of the first auction. In an embodiment, the end point of each of the additional auctions is only visible to the user for a specified time period after the user places a bid. That is, placing a bid in the first auction may enable the user to see the end point of at least one mini-auctions for a period of time, 30 seconds for example. If the user wishes to continue to see the end point of the mini-auctions, in this embodiment, he must place a bid at least once every 30 seconds.

The bids may be placed manually or through an automated bidding process in which the first user indicates a maximum bid they are willing to make, a maximum number of bids they are willing to place, how often they would like bids placed, or some other indicator, and the system will place a new bid accordingly. The automated bidding process may be set up such that a bid is placed at timed intervals, for example, a bid may be placed every five seconds or every thirty seconds.

In Step 308, the system enables the first user to simultaneously place a bid on each of the displayed first electronic auction and additional electronic auctions. In various embodiments, the system may notify the user that the bid has been accepted. The user's name, username, or other indicator of his identity may be displayed onscreen as such a notification, in an embodiment. In various embodiments, the system may display the highest or most recent bidder for the auction. In other embodiments, the color of the grid space may change to indicate that the user has placed a bid.

Shown in Step 309, the system may end at least one of the additional electronic auctions upon receipt of the predetermined number of bids for that auction. As noted above, each of the additional electronic auctions may end prior to the end of the first electronic auction, in an embodiment. In Step 210, the system may then end the first electronic auction, after all of the additional electronic auctions displayed within the first electronic auction have ended. With regard to each auction, the system may determine a winner of the ended auction. The winner of each auction may be indicated to all users or to just the winner of the auction. Any manner of notifying the winner of the action may be utilized. In an embodiment, multiple first electronic auctions are displayed and conducted simultaneously. That is, each first electronic auction may be displayed in a grid format with numerous mini-auctions displayed and conducted within the grid format of each first electronic auction. This is shown in FIG. 2 with the additional electronic auctions depicted as mini-auctions.

Many modifications and other embodiments of the invention will come to mind to one skilled in the art to which this invention pertains having the benefit of the teachings presented in the foregoing descriptions and the associated drawings. While examples discussed above cover the use of the invention in the context a content management service, the invention may be used in any other suitable context. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

What is claimed is:

1. An electronic auction system comprising a server connected to at least one user computer comprising a display, wherein the system:
a. determines a first number of bids that must be received from at least one user, the receipt of which will end a reserve period of a first electronic auction;
b. determines at least one additional number of bids that must be received from at least one user, the receipt of which will end at least one additional electronic auction, wherein the additional number of bids is fewer than the first number of bids;
c. simultaneously displays the first electronic auction and the at least one additional electronic auction on the at least one user computer, wherein the end point of the at least one additional electronic auction is displayed within the display of the first electronic auction;
d. ends each additional electronic auction upon receipt of the predetermined number of bids for that auction; and
e. ends the first electronic auction after all additional electronic auctions displayed within the first electronic auction have ended.

2. The system of claim 1 wherein the computer is selected from the group consisting of a personal computer, a smart phone, a tablet, and a mobile device.

3. The system of claim 1 wherein the end point of each of the at least one additional auction is visible to the user for a specified time period after the user places a bid.

4. The system of claim 1 wherein the number of bids that must be received to end the reserve period of the first electronic auction is the same number of bids that must be received to end the first electronic auction.

5. The system of claim 1 wherein each bid placed in the first electronic auction is displayed in a grid format and the end point of each of the additional auctions is displayed on one grid space within the grid format of the first electronic auction.

6. The system of claim 5 wherein the end point of each of the additional auctions is displayed as a symbol on one grid space within the grid format of the first electronic auction.

7. The system of claim 1 wherein the server receives a request, from at least one user computer, to purchase a first quantity of electronic bids for use in at least one electronic auction.

8. The system of claim 7 wherein the server allocates a first quantity of electronic bids to an account associated with the user.

9. The system of claim 1 wherein each bid that at least one user places is simultaneously placed in both the first electronic auction and at least one additional electronic auction.

10. The system of claim 1 wherein multiple first electronic auctions are conducted simultaneously.

11. The system of claim 10 wherein multiple additional electronic auctions are displayed and conducted within each first electronic auction.

12. A method of providing an electronic auction over a network to at least one user computer, the method comprising receiving a request, at an auction server, from the at least one user computer to participate in an auction, wherein the auction system:
a. determines a first number of bids that must be received from at least one user, the receipt of which will end a reserve period of a first electronic auction;
b. determines at least one additional number of bids that must be received from at least one user, the receipt of which will end at least one additional electronic auction, wherein the additional number of bids is fewer than the first number of bids, and wherein the first electronic auction and the at least one additional electronic auction are operatively linked;
c. ends each additional electronic auction upon receipt of the predetermined number of bids for that auction; and
d. ends the first electronic auction after all additional electronic auctions have ended.

13. The method of claim 1 wherein the auction server receives a request, from at least one user computer, to purchase a first quantity of electronic bids for use in at least one electronic auction.

14. The method of claim 14 wherein the auction server allocates a first quantity of electronic bids to an account associated with the user.

15. The method of claim 15, wherein the user simultaneously places one bid in the first and additional electronic auctions.

16. The method of claim 13 wherein each bid that at least one user places simultaneously increments the progress of the first electronic auction and at least one additional electronic auction.

17. The method of claim 13 wherein each bid that at least one user places simultaneously increments the progress of the at least one additional electronic auction but does not increment the progress of the first electronic auction.

18. The method of claim 13 wherein the end point of each of the additional electronic auctions is visible to the user for a specified time period after the user places a bid.

19. The method of claim 13 wherein the number of users that may participate in the first electronic auction and the at least one additional electronic auction is limited.

20. A method of providing an electronic auction over a network to at least one user computer, the method comprising receiving a request, at an auction server, from the at least one user computer to participate in an auction, wherein the auction system:
a. determines a first number of bids that must be received from at least one user, the receipt of which will end a reserve period of a first electronic auction;
b. determines at least one additional number of bids that must be received from at least one user, the receipt of which will end at least one additional electronic auction, wherein the additional number of bids is fewer than the first number of bids;
c. receives at least one bid from at least one user, wherein each bid received simultaneously increments the progress of both the first electronic auction and at least one additional electronic auction;
d. ends each additional electronic auction upon receipt of the predetermined number of bids for that auction; and
e. ends the first electronic auction after all additional electronic auctions have ended.

21. The system of claim 21 additionally comprising multiple additional electronic auctions.

22. The system of claim 21 additionally comprising displaying each bid that is received to the user.

23. The system of claim 21 wherein the end point of the at least one additional electronic auction is displayed as a symbol.
